(19) United States
(12) Patent Application Publication
(10) Pub. No.: US 2018/0190058 A1
(43) Pub. Date: Jul. 5, 2018

(54) LIVE VOTING ON TIME-DELAYED CONTENT AND AUTOMTICALLY GENERATED CONTENT

(71) Applicants: Glen J. Anderson, Beaverton, OR (US); John Gaffrey, Hillsboro, OR (US); Meng Shi, Hillsboro, OR (US)

(72) Inventors: Glen J. Anderson, Beaverton, OR (US); John Gaffrey, Hillsboro, OR (US); Meng Shi, Hillsboro, OR (US)

(21) Appl. No.: 15/396,168

(22) Filed: Dec. 30, 2016

(51) Int. Cl. G07C 13/00; G06T 19/20

(52) U.S. Cl. CPC G07C 13/00; G06T 19/20

(57) ABSTRACT

Systems, apparatuses and methods may provide for allowing multiple viewers to vote on a manner in which time-delayed content may be displayed. Alternate branches of pre-recorded content, each including alternate endings, may be displayed based on the expressed desires of a majority of viewers. The system also generates content from existing three-dimensional (3D) models of characters, and specific settings and backgrounds and 3D models generated from new images. Automatically generated content, generated from the existing 3D models or the 3D models created from the new images, may be displayed according to the expressed desires of a majority of viewers.

### BACKGROUND

### Technical Field

Embodiments generally relate to technology that enables live voting on time-delayed content and pre-existing content.

### Discussion

During the viewing of broadcast television programs, viewers of the programs may be able to perform live voting on various aspects of the programs, thereby creating an interactive experience by enabling the viewers to participate in the streaming programs.

With the advent of personal video recorders (PVRs) such as digital video recorders (DVRs), the time-shifting of media content has become more appealing than the viewing of live content, since viewers have the ability to perform functions such as pausing of the media content, playing back the media content, and skipping over advertisements during playback of the time-delayed media content.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is block diagram of an example of a media system according to an embodiment;

FIG. 2 is an illustration of an example of a live voting apparatus according to an embodiment;

FIG. 3 is another illustration of an example of a live voting system according to an embodiment;

FIG. 4 illustrates a flowchart of an example of a method of operating a live voting apparatus according to an embodiment;

FIGS. 5A and 5B illustrate flowcharts of examples of methods of generating and transmitting content according to another embodiment;

FIG. 6 is a block diagram of an example of a processor according to an embodiment; and

FIG. 7 is a block diagram of an example of a computing system according to an embodiment.

### DETAILED DESCRIPTION OF EXEMPLARY EMBODIMENTS

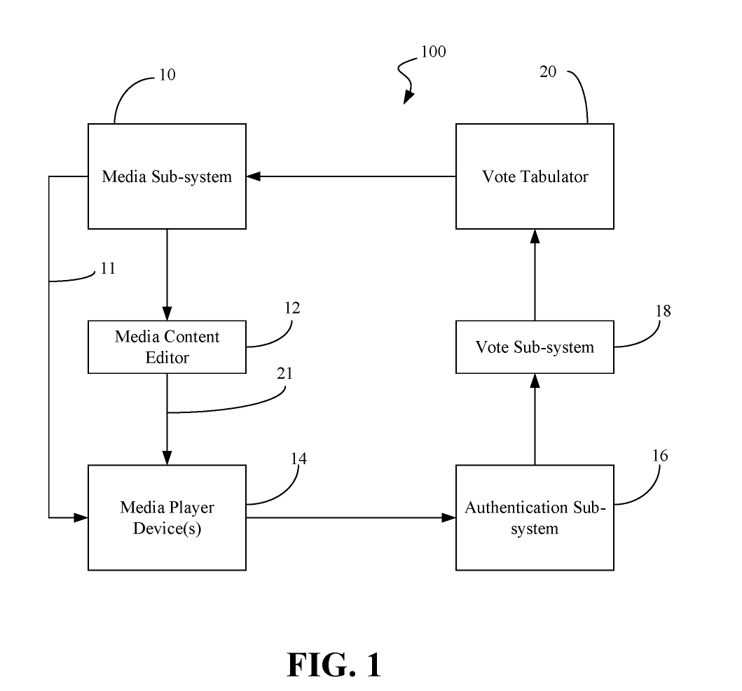

Turning now to FIG. 1, a media system 100 is illustrated. The live voting system 100 may include a media sub-system 10, a media content editor 12, one or more media players 14, an authentication sub-system 16, a vote sub-system 18, and a vote tabulator 20. Although the vote tabulator 20 is illustrated as being separate from the vote sub-system 18, this is only exemplary, and the vote tabulator 20 may be incorporated as an entity within the vote sub-system 18. According to an exemplary embodiment of the application, the media sub-system 10, the authentication sub-system 16, and the vote sub-system 18 may also be implemented as individual servers or alternately, as a single server system.

According to the exemplary embodiment, time-delayed media content 11 may be streamed to one or more media player devices 14. The time-delayed or time-shifted content 11 may refer to content or programming that has been recorded on a storage medium such as a DVR, to be viewed after the live broadcast has been transmitted. According to an exemplary embodiment, the time-delayed content may be recorded with alternate branches of content, each with alternate endings. Specifically, the pre-recorded content may include media that is prerecorded with alternate branches, each of the alternate branches including alternate endings of the particular storyline or content.

For example, if the time-delayed media content 11 relates to an episode of a particular television program (e.g., “Crime Series A”), the episode may be pre-recorded with alternate branches, each of the alternate branches including alternate endings where the villain is portrayed as being different characters. Additionally, if the time-delayed content relates to a golf tournament, the golf tournament may be pre-recorded where the tournament is won by any number of different players.

According to yet another exemplary embodiment, media content 11 may be created with three dimensional (3D) models that follow programmed instructions. For example, the media content 11 may be created with 3D models of cartoon characters. This content may be created at any point before or even during viewing of the content, and thus may be automatically generated. For example during a pause in viewing, the content may be created in response to user inputs. As discussed below, viewers may be able to vote on changing the characters, setting, or background of the content created with the 3D models to different models, settings, or backgrounds. In response to the result of the voting, media content may be automatically created using previously created 3D models. The automatically created content may be added to the prerecorded content.

According to another exemplary embodiment, the 3D models may be created based on newly introduced images, such as, for example, a 3D rendering of a user's face. This is only exemplary, and the newly introduced images may be 3D renderings selected by the users.

One or more users of the media player devices 14 may view the time-delayed media content 11 by signing-in to the authentication sub-system 16, and undergoing an authentication process. The users may sign-in to the authentication sub-system 16 in order to be able to view media content simultaneously, thus allowing voting on a manner that the content should proceed. Although the authentication sub-system 16 is shown as a separate entity, this is only exemplary, and the authentication sub-system 16 may be incorporated in the vote sub-system 18. For example, the authentication process and the tabulation of the votes may be conducted by a single sub-system or server. The authentication process may include verification that the one or more viewers are authorized to view the time-delayed content 11, or verification that the one or more viewers are authorized to use the one or more media player devices 14.

Upon successful authentication of the one or more viewers, the viewers may vote on desired events to take place in the time-delayed media content. Specifically, the one or more viewers may input votes on an alternate branch of media content that includes an alternate ending of the storyline or content. For example, the one or more viewers may cast votes on the storyline of a particular episode of a time-delayed media content to be switched in an alternate direction or branch, with an alternate ending.

Additionally, media content containing pre-existing 3D models may be created on the basis of a result of the inputted votes. Alternately, 3D content may be created with new images such as a 3D rendering of a user's face or other selected 3D images.

The cast votes may be received at the vote sub-system 18 and tabulated at vote tabulator 20. On the basis of the tabulated votes, a media content editor 12 may generate one or more alternate branches of the time-delayed content, each of the alternate branches of content including an alternate ending of the time-delayed media content. The alternate branches of media content may be streamed as adjusted media content 21 to the one or more media player devices 14. Additionally, as discussed above, 3D content may be added to the time delayed media content based on a result of the tabulated votes in order to, for example, change a characters' appearance in the time-delayed content, add a character to the time-delayed media content, or change the setting or background of the time-delayed content. Although the media content editor 12 is illustrated as a separate entity in FIG. 1, this is exemplary, and the media content editor 12 may be incorporated in the media sub-system 10. For example, the processes performed by the media editor 12 and the processes performed by the media sub-system 10 may be conducted by a single sub-system or server.

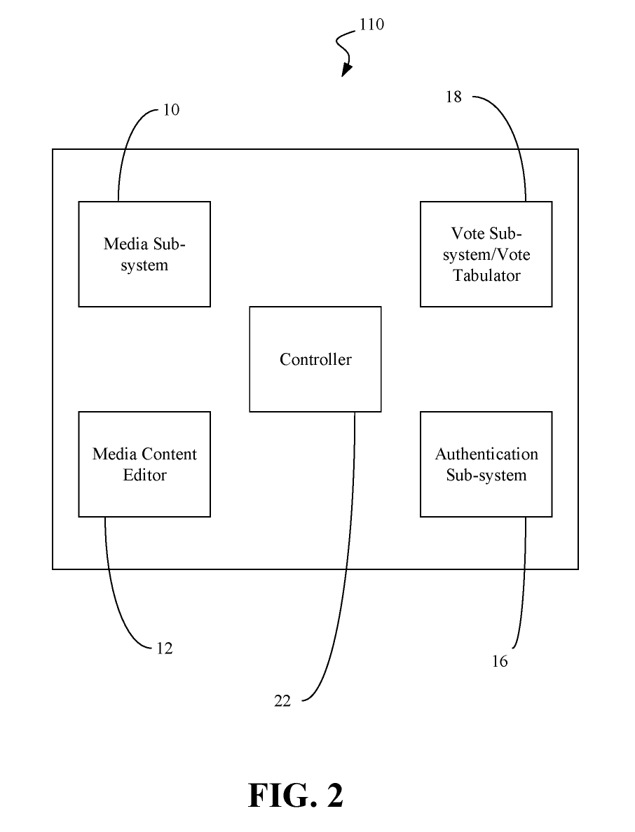

Turning now to FIG. 2, a live voting apparatus 110 according to an embodiment is illustrated. The embodiment in FIG. 2 illustrates the media sub-system 10, the media content editor 12, the authentication sub-system 16, the vote sub-system 18 (e.g., tabulator), and a controller 22.

The illustrated media sub-system 10 may store pre-existing content. The pre-existing content may include existing media content or content that is generated from existing 3D models of characters, (for example, cartoon characters).

The illustrated authentication sub-system 16 may receive sign-in requests from one or more viewers, and perform an authentication process to authenticate the one or more viewers. Upon successful authentication, the one or more viewers may simultaneously view time-delayed media content that is stored in the media sub-system 10. The media content may be generated with alternate branches of content that include alternate endings.

After the one or more viewers have viewed the time delayed media content, and the alternate branches of the media content that include alternate endings of the media content, the one or more viewers may cast votes on desired events to take place in the time-delayed content. The illustrated vote sub-system/vote tabulator 18 may receive the cast votes, tabulate the votes and determine the wishes of a majority of the viewers.

The media content editor 12 may receive the result of the tabulated votes from the vote sub-system/vote tabulator 18, and adjust an output of the media content on the basis of the tabulated votes. Adjusting the output of the media content may include generating an alternate branch of a storyline with an alternate ending of the storyline, automatically creating content based on the 3D models, or creating content based on newly introduced 3D renderings. The automatically generated content that is based on the 3D models or the newly introduced 3D renderings may also be added to the pre-recorded media content.

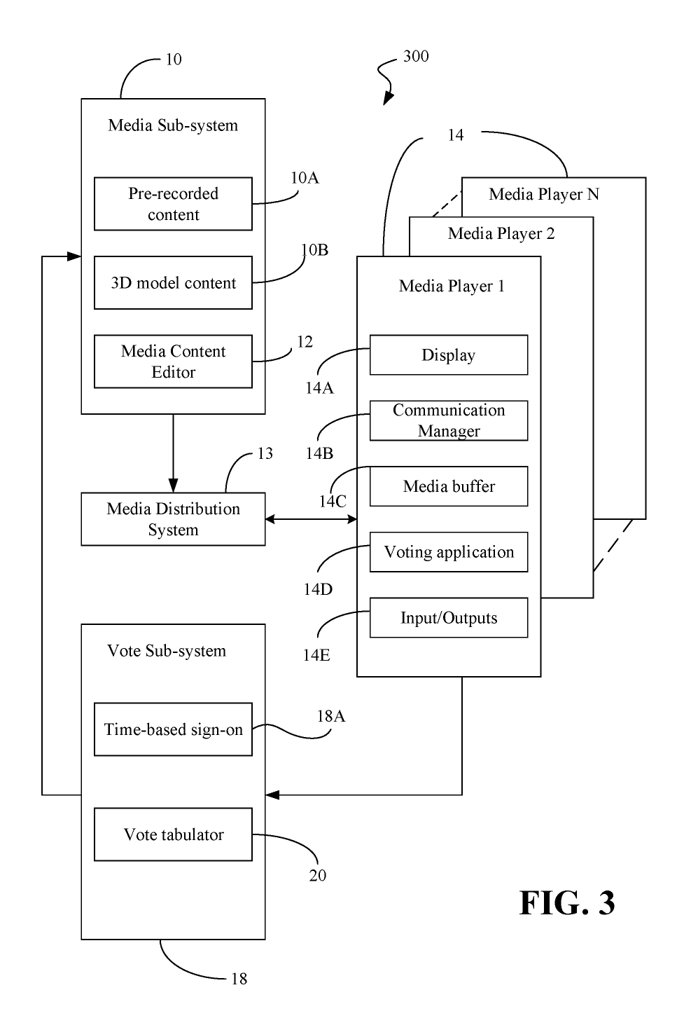

Turning now to FIG. 3, media system 300 according to another embodiment is illustrated. The illustrated system includes a media sub-system 10, a media distribution system 13, a vote sub-system 18, and one or more media player devices 14.

The illustrated media sub-system 10 may store pre-recorded or time-delayed media content 10A or 3D model content 10B. The illustrated media sub-system 10 may include a media content editor 12, which edits or adjusts media content on the basis of the tabulated voting requests of a majority of viewers. A media distribution system 13 may transmit the adjusted media content to the one or more media player devices 14.

The illustrated vote sub-system 18 may include a vote tabulator 20. One or more users of the one or more media player devices 14 may sign on (18A) to the vote sub-system so that the one or more users may be able to simultaneously view media content. The illustrated one or more media player devices 14 may include a display 14A, a communication manager 14B, a media buffer 14C, a voting application 14D, and various input/output ports 14E. The media player devices 14 may include, for example, a smart television (TV), display (e.g., liquid crystal display (LCD), cathode ray tube (CRT) monitor, plasma display, etc.), personal digital assistant (PDA) imaging device, mobile Internet device (MID), any smart device such as a smart phone, smart tablet, and so forth, or any combination thereof.

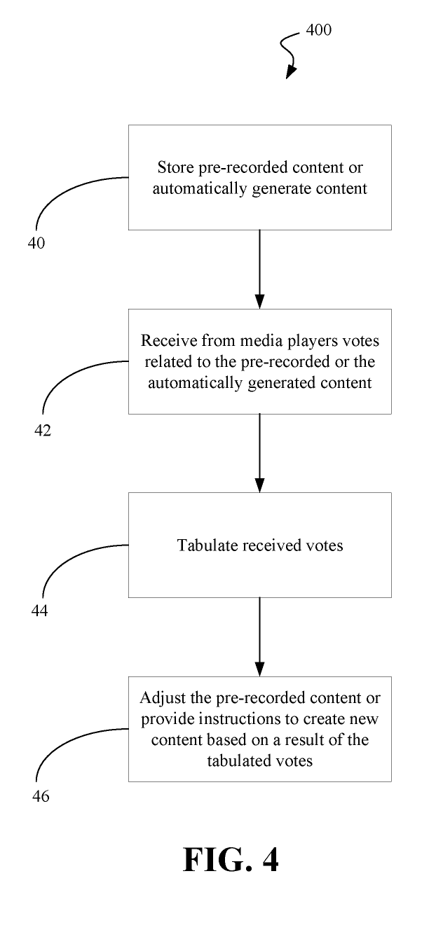

FIG. 4 illustrates a method 400 of performing live voting on time-delayed content according to an embodiment. The method 400 may generally be implemented in a compression-enabled memory apparatus as described herein. More particularly, the method 400 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 400 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 40 may provide for storing, by a media sub-system 10 (FIG. 1), pre-recorded content or automatically generating content, for example, 3D model content. Illustrated processing block 42 may provide for receiving, from one or more media players, votes related to the pre-recorded content or the automatically generated content. Specifically, the pre-recorded content may be created with alternate branches of content related to an original content, the alternate branches of content may include alternate endings of the original content.

The votes that are inputted by the one or more viewers may be tabulated at processing block 44. The tabulation of the votes may be done by a vote tabulator 20 (FIG. 3) located in the vote sub-system 18 (FIG. 3). The tabulation of the votes may determine a majority of viewers of a group of viewers who, for example, would like to view an alternate branch of particular media content being viewed by the group of viewers or who would like to produce new content.

On the basis of the determination of the requests of a majority of viewers, illustrated processing block 46 may provide for adjusting the pre-recorded or time-delayed content by generating an alternate branch of media content, or providing instructions for creating new automatically generated content that may include selected 3D models.

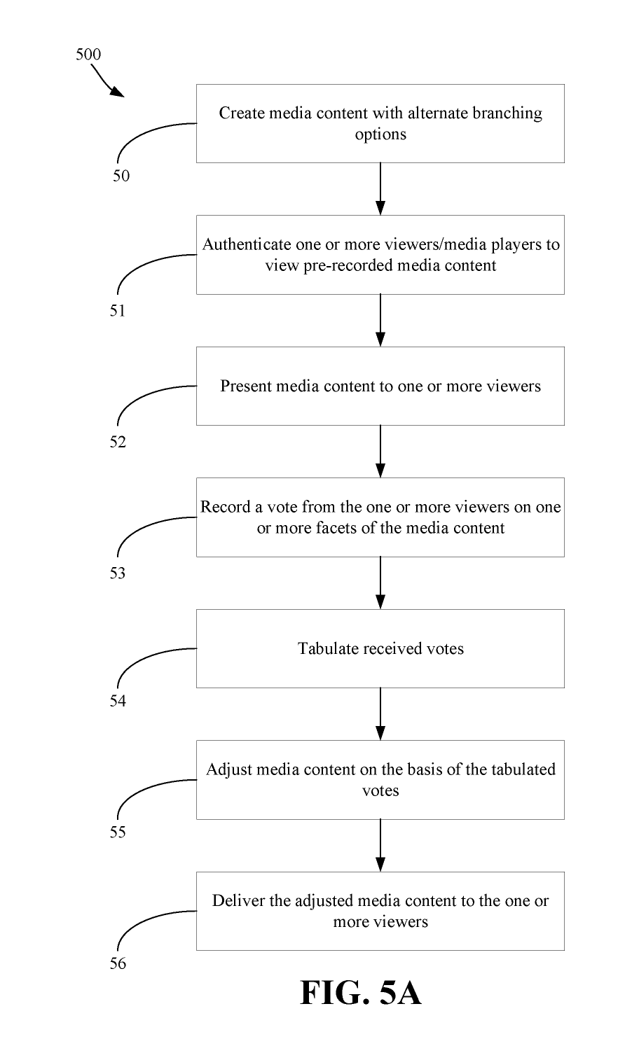

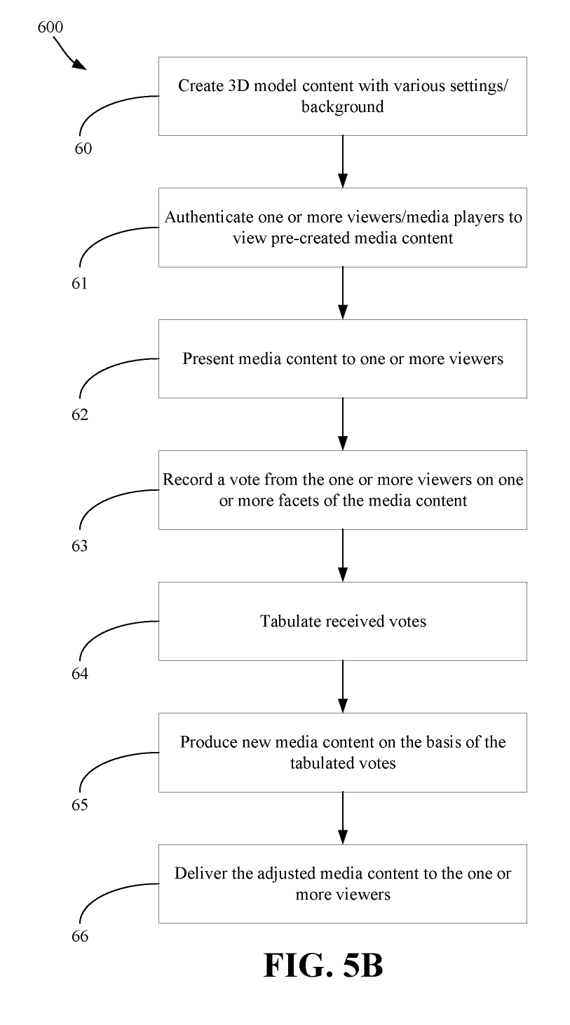

Turning now to FIG. 5A, a method 500 of generating and transmitting pre-recorded content with alternate branches is shown. The method 500 may generally be implemented in a device such as, for example, a smart phone, tablet computer, notebook computer, tablet computer, convertible tablet, PDA, MID, wearable computer, desktop computer, media player, smart TV, gaming console, etc., already discussed. More particularly, the method 500 may be implemented as a set of logic instructions stored in a machine- or computer-readable medium of a memory such RAM, ROM, PROM, firmware, flash memory, etc., in configurable logic such as, for example, PLAs, FPGAs, CPLDs, in fixed-functionality logic hardware using circuit technology such as ASIC, CMOS or TTL technology, or any combination thereof. For example, computer program code to carry out operations shown in method 500 may be written in any combination of one or more programming languages, including an object oriented programming language such as JAVA, SMALLTALK, C++ or the like and conventional procedural programming languages, such as the “C” programming language or similar programming languages.

The illustrated method begins at processing block 50, where media content is created with alternate branches of content. The media content may be created in media sub-system 10 (FIG. 1), and may include programming that is created with alternate storylines or alternate branches that may be of interest to different viewers. The alternate branches of media content may be created with alternate endings that are different from the ending of the original content.

With continuing reference to FIG. 5A, at processing block 51, one or more viewers may sign-in to an authentication sub-system 16 (FIG. 1) in order to simultaneously view pre-recorded media content. Upon successful authentication, the pre-recorded media content is presented to the one or more viewers at processing block 52.

As illustrated in processing block 53, one or more of the viewers may record or cast a vote on one or more facets of the pre-recorded media content being viewed. The votes may be recorded and tabulated on a vote sub-system 18 (FIG. 3) at processing block 54. A result of the tabulated votes may then be transmitted to the media sub-system 10 (FIG. 1).

At processing block 55, the pre-recorded content may be adjusted based on a result of the tabulated votes. For example, if a majority of viewers vote to see a particular alternate branch of media content with an alternate ending, the media content may be adjusted to transmit the requested alternate branch of media content. Alternately, if a majority of the viewers vote to create media content using preexisting 3D characters or models, or alternately, create media content using 3D content based on newly introduced images, such as a user's facial features, the media content may be adjusted to reflect the requested automatically created content.

At illustrated processing block 56, the adjusted content may be transmitted to the one or more viewers.

Turning now to FIG. 5B, a method 600 of automatically creating 3D content is shown. The method 600 may generally be implemented in a device such as, for example, a smart phone, tablet computer, notebook computer, tablet computer, convertible tablet, PDA, MID, wearable computer, desktop computer, media player, smart TV, gaming console, etc., already discussed. More particularly, the method 600 may be implemented as a set of logic instructions stored in a machine- or computer-readable medium of a memory such RAM, ROM, PROM, firmware, flash memory, etc., in configurable logic such as, for example, PLAs, FPGAs, CPLDs, in fixed-functionality logic hardware using circuit technology such as ASIC, CMOS or TTL technology, or any combination thereof. For example, computer program code to carry out operations shown in method 600 may be written in any combination of one or more programming languages, including an object oriented programming language such as JAVA, SMALLTALK, C++ or the like and conventional procedural programming languages, such as the “C” programming language or similar programming languages.

The illustrated method begins at processing block 60, where 3D model content with various settings and/or backgrounds may be created. The 3D model content may be created in media sub-system 10 (FIG. 1).

In illustrated processing block 61, one or more viewers may sign-in to an authentication sub-system 16 (FIG. 1) in order to simultaneously view 3D media content. The 3D media content may include cartoon characters and 3D character models, but is not limited thereto. Upon successful authentication, the pre-recorded 3D media content is presented to the one or more viewers at processing block 62.

As illustrated in processing block 63, one or more of the viewers may record or cast a vote on one or more facets of the automatically generated 3D media content being viewed. The votes may be recorded and tabulated on a vote sub-system 18 (FIG. 3) at processing block 64. A result of the tabulated votes may then be transmitted to the media sub-system 10 (FIG. 1).

At processing block 65, the automatically generated content may be adjusted based on a result of the tabulated votes. For example, if a majority of viewers vote to see a different character or a different setting or background in the 3D media content being viewed, the 3D media content may be adjusted to reflect the requested change.

At illustrated processing block 66, the adjusted content may be transmitted to the one or more viewers.

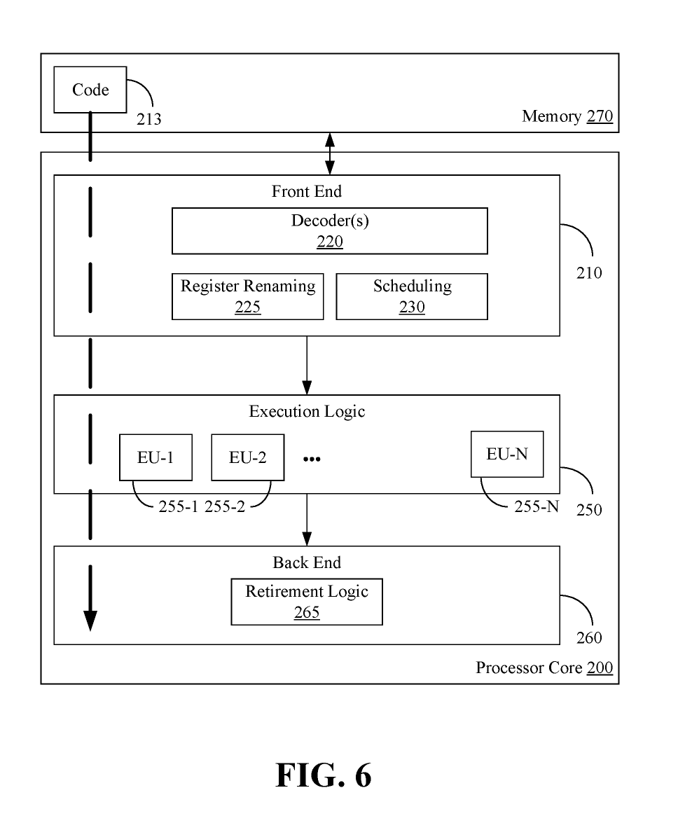

FIG. 6 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 6, a processing element may alternatively include more than one of the processor core 200 illustrated in FIG. 6. The processor core 200 may be a single-threaded core or, for at least one embodiment, the processor core 200 may be multithreaded in that it may include more than one hardware thread context (or “logical processor”) per core.

FIG. 6 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 400 (FIG. 4), the method 500 (FIG. 5A), and the method 600 (FIG. 5B) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 6, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

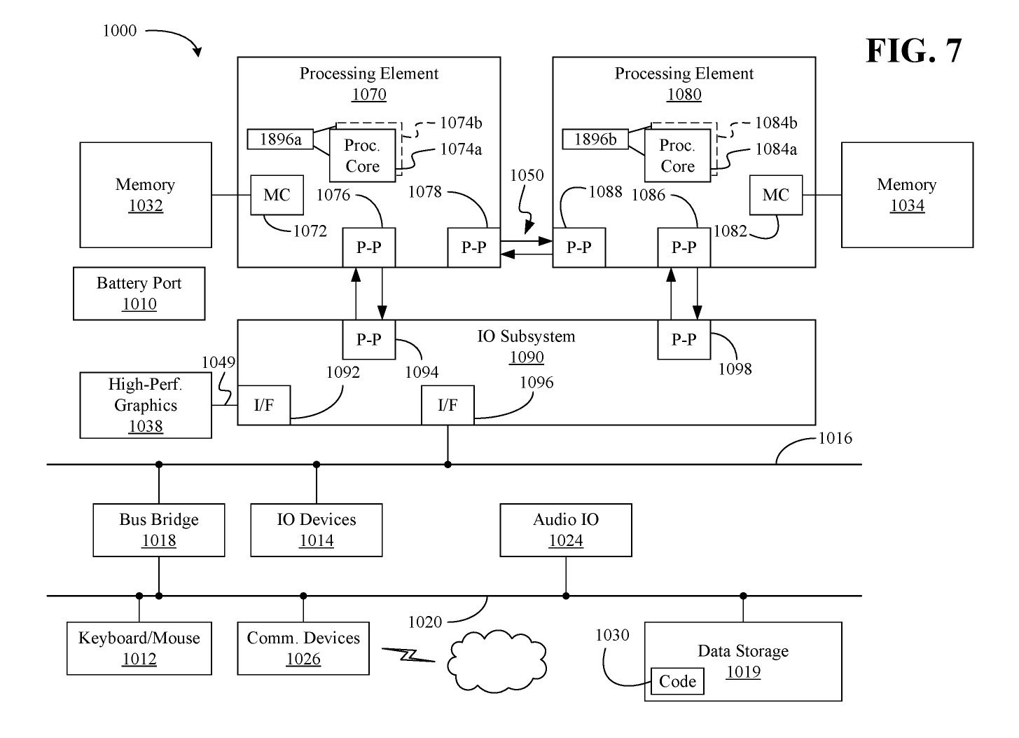

Referring now to FIG. 7, shown is a block diagram of a computing system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 400 (FIG. 4), the method 500 (FIG. 5A), and the method 600 (FIG. 5B), already discussed, and may be similar to the code 213 (FIG. 6), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

### Additional Notes and Examples

Example 1 may include an electronic voting system including a media sub-system to one or more of store pre-recorded content or automatically generate content, a media content delivery subsystem to deliver one or more of the pre-recorded content or the automatically generated content to one or more media players, a voting sub-system to receive, from the one or more media players, votes related to the pre-recorded content or the automatically generated content and tabulate the received votes, and an editor to adjust the pre-recorded content or provide instructions to create the automatically generated content based on a result of the tabulated votes.

Example 2 may include the system of example 1, wherein the pre-recorded content includes one or more alternate branches of content, and in adjusting the pre-recorded content, at least one of the one or more alternate branches of content is to be displayed based on a result of the tabulated votes.

Example 3 may include the system of any one of examples 1 and 2 wherein the automatically generated content includes three-dimensional (3D) content.

Example 4 may include the system of example 3, wherein the 3D content is to be added to the pre-recorded content based on a result of the tabulated votes.

Example 5 may include the system of example 1, further comprising an authentication sub-system to authenticate one or more users and authorize simultaneous viewing of the pre-recorded content or the automatically generated content by the one or more users based on a result of the authentication.

Example 6 may include system of example 1, wherein the instructions to create the new automatically generated content include one or more of changing a background of the automatically generated content, changing colors of characters in the automatically generated content, or adding characters to the automatically generated content.

Example 7 may include a pre-recorded media content voting apparatus comprising a media sub-system to store pre-existing content, a vote sub-system to tabulate votes received from one or more media players, wherein the votes are to be related to the pre-existing content, and an editor communicatively coupled to the media sub-system and the vote sub-system, the editor to one or more of adjust the pre-existing content or provide new content creation instructions based on a result of the tabulated votes.

Example 8 may include the apparatus of example 7, wherein the pre-existing content is to comprise pre-recorded content that includes one or more alternate branches of content, and in adjusting the pre-existing content at least one of the one or more alternate branches of content is to be displayed based on a result of the tabulated votes.

Example 9 may include the apparatus of any one of examples 7 and 8, wherein the pre-existing content is to comprise automatically generated content that includes three-dimensional (3D) content.

Example 10 may include the apparatus of example 9, wherein the editor is to add the 3D content to the pre-existing content based on a result of the tabulated votes.

Example 11 may include the apparatus of example 7, further comprising an authentication sub-system to authenticate one or more users and authorize simultaneous viewing of the pre-existing content by the one or more users based on a result of the authentication.

Example 12 may include the apparatus of example 7, wherein the new content creation instructions include instructions to one or more of change a background of the automatically generated content, change colors of characters in the pre-existing content, or add characters to the pre-existing content.

Example 13 may include a method for voting on pre-recorded media content comprising one or more of storing pre-recorded content or automatically generating content, receiving, from one or more media players, votes related to the pre-recorded content or the automatically generated content and tabulating the received votes, and adjusting the pre-recorded content or providing instructions to create the automatically generated content based on a result of the tabulated votes.

Example 14 may include the method of example 13, wherein the pre-recorded content includes one or more alternate branches of content, and in adjusting the pre-recorded content, at least one of the one or more alternate branches of content is to be displayed based on a result of the tabulated votes.

Example 15 may include the method of any one of examples 13 and 14, wherein the automatically generated content includes three-dimensional (3D) content.

Example 16 may include the method of example 15, wherein the 3D content is to be added to the pre-recorded content based on a result of the tabulated votes.

Example 17 may include the method of example 13, further comprising authenticating one or more users and authorizing simultaneous viewing of the pre-recorded content or the automatically generated content by the one or more users based on a result of the authentication.

Example 18 may include the method of example 13, wherein the instructions to create the automatically generated content include one or more of changing a background of the automatically generated content, changing colors of characters in the automatically generated content, or adding characters to the automatically generated content.

Example 19 may include at least one computer readable storage medium comprising a set of instructions, which when executed by an apparatus, cause the apparatus to one or more of store pre-recorded content or automatically generate content, receive, from one or more media players, votes related to the pre-recorded content or the automatically generated content and tabulate the received votes, and adjust the pre-recorded content or provide instructions to create new automatically generated content based on a result of the tabulated votes.

Example 20 may include the at least one computer readable storage medium of example 19, wherein the pre-recorded content includes one or more alternate branches of content, and in adjusting the pre-recorded content, at least one of the one or more alternate branches of content is to be displayed based on a result of the tabulated votes.

Example 21 may include the at least one computer readable storage medium of any one of examples 19 and 20, wherein the automatically generated content includes three-dimensional (3D) content.

Example 22 may include the at least one computer readable storage medium of example 21, wherein the 3D content is to be added to the pre-recorded content based on a result of the tabulated votes.

Example 23 may include the at least one computer readable storage medium of example 19, further comprising authenticating one or more users and authorizing simultaneous viewing of the pre-recorded content or the automatically generated content by the one or more users based on a result of the authentication.

Example 24 may include the at least one computer readable storage medium of example 19, wherein the instructions to create the automatically generated content includes one or more of changing a background of the automatically generated content, changing colors of characters in the automatically generated content, or adding characters to the automatically generated content.

Example 25 may include a pre-recorded media content voting apparatus comprising means for one or more of storing pre-recorded content or automatically generating content, means for receiving, from one or more media players, votes related to the pre-recorded content or the automatically generated content and tabulating the received votes, and means for adjusting the pre-recorded content or providing instructions to create the automatically generated content based on a result of the tabulated votes.

Example 26 may include the apparatus of example 25, wherein the pre-recorded content is to include one or more alternate branches of content, and adjusting the pre-recorded content, at least one of the one or more alternate branches of content is to be displayed based on a result of the tabulated votes.

Example 27 may include the apparatus of any one of examples 25 and 26, wherein the automatically generated content is to include three-dimensional (3D) content.

Example 28 may include the apparatus of example 27, wherein the 3D content is to be added to the pre-recorded content based on a result of the tabulated votes.

Example 29 may include the apparatus of example 25, further comprising means for authenticating one or more users and authorizing simultaneous viewing of the pre-recorded content or the automatically generated content by the one or more users based on a result of the authentication.

Example 30 may include the apparatus of example 25, wherein the instructions to create the automatically generated content are to include one or more of changing a background of the automatically generated content, changing colors of characters in the automatically generated content, or adding characters to the automatically generated content.

Example 31 may include a processor-based electronic voting system comprising a processor, one or more computer readable storage devices coupled to the processor, a media sub-system, coupled to the processor, to one or more of store pre-recorded content or automatically generate content, a media content delivery subsystem coupled to the processor, to deliver one or more of the pre-recorded content or the automatically generated content to one or more media players, a voting sub-system coupled to the processor, to receive, from the one or more media players, votes related to the pre-recorded content or the automatically generated content, store the received votes in one or more of the storage devices, and tabulate the received votes, and an editor to adjust the pre-recorded content or provide instructions to create the automatically generated content based on a result of the tabulated votes.

Embodiments described herein are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. An electronic voting system comprising:
a media sub-system to one or more of store pre-recorded content or automatically generate content;
a media content delivery subsystem to deliver one or more of the pre-recorded content or the automatically generated content to one or more media players;
a voting sub-system to receive, from the one or more media players, votes related to the pre-recorded content or the automatically generated content and tabulate the received votes, and
an editor to adjust the pre-recorded content or provide instructions to create the automatically generated content based on a result of the tabulated votes.

2. The system of claim 1, wherein the pre-recorded content includes one or more alternate branches of content, and in adjusting the pre-recorded content, at least one of the one or more alternate branches of content is displayed based on a result of the tabulated votes.

3. The system of claim 1 wherein the automatically generated content includes three-dimensional (3D) content.

4. The system of claim 3, wherein the 3D content is to be added to the pre-recorded content based on a result of the tabulated votes.

5. The system of claim 1, further comprising an authentication sub-system to authenticate one or more users and authorize simultaneous viewing of the pre-recorded content or the automatically generated content by the one or more users based on a result of the authentication.

6. The system of claim 1, wherein the instructions to create the automatically generated content include one or more of changing a background of the automatically generated content, changing colors of characters in the automatically generated content, or adding characters to the automatically generated content.

7. An apparatus comprising:
a media sub-system to store pre-existing content;
a vote sub-system to tabulate votes received from one or more media players, wherein the votes are to be related to the pre-existing content; and
an editor communicatively coupled to the media sub-system and the vote sub-system, the editor to one or more of adjust the pre-existing content or provide new content creation instructions based on a result of the tabulated votes.

8. The apparatus of claim 7, wherein the pre-existing content is to comprise pre-recorded content that includes one or more alternate branches of content, and in adjusting the pre-existing content, at least one of the one or more alternate branches of content is displayed based on a result of the tabulated votes.

9. The apparatus of claim 7, wherein the pre-existing content is to comprise automatically generated content that includes three-dimensional (3D) content.

10. The apparatus of claim 9, wherein the editor is to add the 3D content to the pre-existing content based on a result of the tabulated votes.

11. The apparatus of claim 7, further comprising an authentication sub-system to authenticate one or more users and authorize simultaneous viewing of the pre-existing content by the one or more users based on a result of the authentication.

12. The apparatus of claim 7, wherein the new content creation instructions include instructions to one or more of change a background of the automatically generated content, change colors of characters in the pre-existing content, or add characters to the pre-existing content.

13. A method comprising:
one or more of storing pre-recorded content or automatically generating content;
receiving, from one or more media players, votes related to the pre-recorded content or the automatically generated content and tabulating the received votes, and
adjusting the pre-recorded content or providing instructions to create the automatically generated content based on a result of the tabulated votes.

14. The method of claim 13, wherein the pre-recorded content includes one or more alternate branches of content, and in adjusting the pre-recorded content, at least one of the one or more alternate branches of content is displayed based on a result of the tabulated votes.

15. The method of claim 13, wherein the automatically generated content includes three-dimensional (3D) content.

16. The method of claim 15, wherein the 3D content is to be added to the pre-recorded content based on a result of the tabulated votes.

17. The method of claim 13, further comprising authenticating one or more users and authorizing simultaneous viewing of the pre-recorded content or the automatically generated content by the one or more users based on a result of the authentication.

18. The method of claim 13, wherein the instructions to create the automatically generated content include one or more of changing a background of the automatically generated content, changing colors of characters in the automatically generated content, or adding characters to the automatically generated content.

19. At least one computer readable storage medium comprising a set of instructions, which when executed by an apparatus, cause the apparatus to:
one or more of store pre-recorded content or automatically generate content;
receive, from one or more media players, votes related to the pre-recorded content or the automatically generated content and tabulate the received votes, and
adjust the pre-recorded content or provide instructions to create the automatically generated content based on a result of the tabulated votes.

20. The at least one computer readable storage medium of claim 19, wherein the pre-recorded content includes one or more alternate branches of content, and in adjusting the pre-recorded content, at least one of the one or more alternate branches of content is displayed based on a result of the tabulated votes.

21. The at least one computer readable storage medium of claim 19, wherein the automatically generated content includes three-dimensional (3D) content.

22. The at least one computer readable storage medium of claim 21, wherein the 3D content is to be added to the pre-recorded content based on a result of the tabulated votes.

23. The at least one computer readable storage medium of claim 19, further comprising authenticating one or more users and authorizing simultaneous viewing of the pre-recorded content or the automatically generated content by the one or more users based on a result of the authentication.

24. The at least one computer readable storage medium of claim 19, wherein the instructions to create the automatically generated content includes one or more of changing a background of the automatically generated content, changing colors of characters in the automatically generated content, or adding characters to the automatically generated content.

25. A processor-based electronic voting system comprising:
a processor;
one or more computer readable storage devices coupled to the processor;
a media sub-system, coupled to the processor, to one or more of store pre-recorded content or automatically generate content;
a media content delivery subsystem coupled to the processor, to deliver one or more of the pre-recorded content or the automatically generated content to one or more media players;
a voting sub-system coupled to the processor, to receive, from the one or more media players, votes related to the pre-recorded content or the automatically generated content, store the received votes in one or more of the storage devices, and tabulate the received votes, and
an editor to adjust the pre-recorded content or provide instructions to create the automatically generated content based on a result of the tabulated votes.
